(19) United States
(12) Patent Application Publication
(10) Pub. No.: US 2004/0111204 A1
(43) Pub. Date: Jun. 10, 2004

(54) Control apparatus and method for automatic transmission

(75) Inventors: Sei Kojima, Nukata-gun (JP); Ryoji Habuchi, Okazaki-shi (JP); Hiroji Taniguchi, Okazaki-shi (JP); Shinya Toyoda, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 10/727,607

(22) Filed: Dec. 5, 2003

(30) Foreign Application Priority Data
Dec. 10, 2002 (JP) 2002-357886

(51) Int. Cl. G06F 19/00

(52) U.S. Cl. 701/59; 701/51

(57) ABSTRACT

A control apparatus and a control method for an automatic transmission which executes a neutral control by which an input clutch that transmits driving force from a driving source to the automatic transmission is released when conditions, being i) a shift lever is in a position corresponding to a forward speed range, ii) an accelerator operation is not being performed, iii) a brake operation is being performed, and iv) a vehicle speed is equal to, or less than, a predetermined vehicle speed, are fulfilled, wherein a hydraulic pressure command value for the input clutch is stored while the neutral control is being executed; and the hydraulic pressure command value for the input clutch is calculated based on the stored hydraulic pressure command value when the neutral control is cancelled so that a normal control is restarted in a case where the conditions become unfulfilled.

### INCORPORATION BY REFERENCE

The disclosure of Japanese Patent Application No. 2002-357886 filed on Dec. 10, 2002, including the specification, drawings and abstract is incorporated herein by reference in its entirety.

### BACKGROUND OF THE INVENTION

1. Field of the Invention

The invention relates to a control of an automatic transmission for a vehicle, and more particularly, to a control apparatus and method for an automatic transmission which executes a neutral control.

2. Description of the Related Art

An automatic transmission to be mounted in a vehicle includes a shifting mechanism which is connected to an engine via a torque converter and the like, and which has a plurality of power transmission paths. This automatic transmission automatically switches gear ratios (i.e., speeds) based on, for example, a throttle opening and vehicle speed. A vehicle having an automatic transmission is typically provided with a shift lever which is operated by a driver into any one of various shift positions (e.g., REVERSE, NEUTRAL, DRIVE). In automatic shift mode there is a “forward drive range” in which the automatic transmission is automatically switched to a predetermined gear ratio/speed.

When a vehicle having this type of automatic transmission is stopped with the shift lever in a position corresponding to a forward speed range, such as DRIVE, driving force from the idling engine is transmitted to the transmission via the torque converter and this force is then transmitted to the wheels, resulting in a phenomenon known as “creeping.” Creeping is extremely useful under certain conditions. For example, it helps to keep the vehicle from slipping backwards and enables a vehicle stopped on an incline to start smoothly. When the driver wants a vehicle that is stationary on a flat road to remain in one spot, however, creeping is unnecessary and must be suppressed by operating the brake. That is, the brake is used to suppress the creeping force from the engine and the fuel efficiency of the engine decreases a corresponding amount.

To improve fuel efficiency, therefore, it has been proposed to put a transmission that is in DRIVE or another forward speed range into a neutral state including a semi-neutral state that resembles neutral when the vehicle is being held stationary by the brake pedal being depressed so as to operate the brake and the accelerator being almost completely closed.

JP(A) 2001-280485 discloses a control apparatus which smoothly brings an automatic transmission out of the neutral state. The control apparatus controls the creeping force of the automatic transmission for a vehicle which is configured so as to reduce the creeping force by reducing the apply force of a frictional element which is applied during running when a predetermined condition is fulfilled in a case where the automatic transmission is in a forward speed range. The control apparatus includes a feedback control circuit which executes a feedback control for the apply force of the frictional element when the predetermined condition is fulfilled; a determination circuit which determines whether a cancellation condition for the feedback control is fulfilled; and a setting circuit which sets an apply force command value for the frictional element immediately after the cancellation condition is fulfilled, based on a parameter value related to the input rotational speed of the automatic transmission when the cancellation condition is fulfilled in a case where it is determined that the cancellation condition is fulfilled.

According to the control apparatus, since the apply force command value for the frictional element is set based on the parameter value corresponding to a change in the input rotational speed of the automatic transmission immediately before the cancellation condition is fulfilled, an optimum apply force command value can be obtained whether the input rotational speed of the automatic transmission immediately before the feedback control is cancelled increases or decreases. As a result, it is possible to improve a response for cancellation, and to reduce a shift shock when the feedback control is cancelled.

The control apparatus disclosed in JP(A) 2001-280485 can calculate, based on the change in the input rotational speed, the apply force command value when the neutral control is cancelled so that the normal control is restarted. However, the control apparatus cannot calculate the apply force command value considering deviation of a relation between a hydraulic pressure command value and an actual hydraulic pressure value due to individual difference of a hydraulic control device. That is, when the neutral control is cancelled, an appropriate actual apply pressure for an input clutch cannot be obtained due to deviation caused by individual difference of the hydraulic control device related to release and application of the input clutch (i.e., a forward clutch) for achieving the neutral control, deviation of hydraulic characteristics of a solenoid valve and deviation of a load of a return spring of the input clutch, deviation of clutch clearance of the input clutch, and the like. As a result, a shock may occur when the neutral control is cancelled. The problem caused by the deviation due to individual difference becomes conspicuous in a case where the apply force command value when the neutral control is cancelled is not controlled by learning (for example, in a case where a battery is reset).

### SUMMARY OF THE INVENTION

In view of the foregoing problem, it is an object of the invention to provide a control apparatus for an automatic transmission which executes a neutral control, and which brings the automatic transmission out of the neutral state without causing a shock.

An aspect of the invention relates to a control apparatus for an automatic transmission which executes a neutral control by which an input clutch that transmits driving force from a driving source to the automatic transmission is released when conditions, being i) a shift lever is in a position corresponding to a forward speed range, ii) an accelerator operation is not being performed, iii) a brake operation is being performed, and iv) a vehicle speed is equal to, or less than, a predetermined vehicle speed, are fulfilled. The control apparatus for an automatic transmission includes a controller which stores a hydraulic pressure command value for the input clutch while the neutral control is being executed, and which calculates, based on the stored hydraulic pressure command value, the hydraulic pressure command value for the input clutch when the neutral control is cancelled so that a normal control is restarted in a case where the conditions become unfulfilled.

Another aspect of the invention relates to a control method of an automatic transmission which executes a neutral control by which an input clutch that transmits driving force from a driving source to the automatic transmission is released when conditions, being i) a shift lever is in a position corresponding to a forward speed range, ii) an accelerator operation is not being performed, iii) a brake operation is being performed, and iv) a vehicle speed is equal to, or less than, a predetermined vehicle speed, are fulfilled. The control method includes the following steps of storing a hydraulic pressure command value for the input clutch while the neutral control is being executed; and calculating, based on the stored hydraulic pressure command value for the input clutch, the hydraulic pressure command value for the input clutch when the neutral control is cancelled so that a normal control is restarted in a case where the conditions become unfulfilled.

According to the control apparatus and the control method for an automatic transmission described above, the hydraulic pressure command value for the input clutch is stored while the neutral control is being executed. Then, based on the stored hydraulic pressure command value, the calculation is performed to obtain the hydraulic pressure command value for the input clutch when the neutral control is cancelled so that the normal control is restarted in the case where the conditions become unfulfilled. Accordingly, a relation between the hydraulic pressure command value while the neutral control is being executed and an actual hydraulic pressure value is set considering individual difference of the input clutch and individual difference of a solenoid valve for controlling the hydraulic pressure to be supplied to the input clutch. Thus, it is possible to calculate the hydraulic pressure command value for the input clutch when the neutral control is cancelled without being influenced by individual difference of the hydraulic control device. As a result, it is possible to provide the control apparatus for an automatic transmission which executes the neutral control, and which brings the automatic transmission out of the neutral state without causing a shock.

### BRIEF DESCRIPTION OF THE DRAWINGS

The above mentioned embodiment and other embodiments, objects, features, advantages, technical and industrial significance of this invention will be better understood by reading the following detailed description of the preferred embodiments of the invention, when considered in connection with the accompanying drawings, in which:

FIG. 1 is a control block diagram of an automatic transmission according to one exemplary embodiment of the invention;

FIG. 2 is a detailed diagram of an ECU shown in FIG. 1;

FIG. 3 is a flowchart illustrating the control structure of a program for calculating a hydraulic pressure command value, which is executed by the ECU; and

FIG. 4 is a timing chart showing the operation of a vehicle in which is mounted the automatic transmission according to the exemplary embodiment of this invention.

### DETAILED DESCRIPTION OF THE PREFERRED EMBODIMENTS

In the following description and the accompanying drawings, the present invention will be described in more detail in terms of exemplary embodiments. In the following description, like components will be designated by like reference characters and repetitive descriptions thereof shall be omitted.

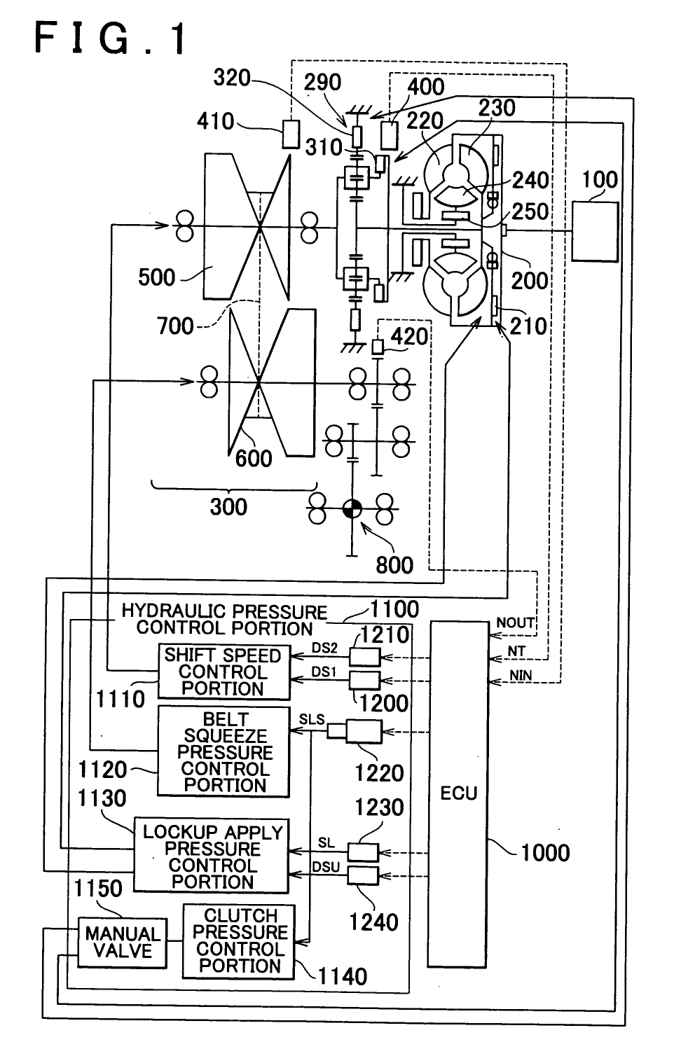

A power train of a vehicle including a control apparatus according to the exemplary embodiment will now be described referring to FIG. 1. The control apparatus according to the exemplary embodiment is realized by an ECU 1000 shown in the drawing. Although the automatic transmission described hereinafter is a belt type continuously variable transmission, the invention is in no way limited thereto.

Referring to FIG. 1, the power train of the vehicle includes an engine 100, a torque converter 200, a forward-reverse switching apparatus 290, a belt type continuously variable transmission (CVT) 300, a differential gear 800, the ECU 1000, and a hydraulic pressure control portion 1100.

An output shaft of the engine 100 is connected to an input shaft of the 200. The engine 100 and the torque converter 200 are connected by a rotating shaft. Accordingly, a rotational speed NE of the output shaft of the engine 100 (i.e., engine speed NE) detected by an engine speed sensor and a rotational speed (pump rotational speed) of the input shaft of the torque converter 200 are the same.

The torque converter 200 has a lockup clutch 210 which directly connects the input shaft and the output shaft, an input shaft side pump impeller 220, an output shaft side turbine impeller 230, and a stator 240 which has a one-way clutch 250 and which acts to increase torque. The torque converter 200 and the CVT 300 are connected by a rotating shaft. A rotational speed NT of the output shaft of the torque converter 200 (i.e., turbine rotational speed NT) is detected by a turbine rotational speed sensor 400.

The CVT 300 is connected to the torque converter 200 via the forward-reverse switching apparatus 290. The CVT 300 includes an input side primary pulley 500, an output side secondary pulley 600, and a metal belt 700 that winds around the primary pulley 500 and the secondary pulley 600. The primary pulley 500 is constructed of a fixed sheave secured to a primary shaft and a movable sheave supported so as to be able to only slide on the primary shaft. The secondary pulley 600 is constructed of a fixed sheave secured to a secondary shaft and a movable sheave supported so as to be able to only slide on the secondary shaft. A rotational speed NIN of the primary pulley in the CVT 300 is detected by a primary pulley rotational speed sensor 410 and a rotational speed NOUT of the secondary pulley in the CVT 300 is detected by a secondary pulley rotational speed sensor 420.

These rotational speed sensors are mounted opposite teeth of gears used to detect rotational speed on the rotating shafts of the primary pulley and the secondary pulley, or on a drive shaft connected to those rotating shafts. These rotational speed sensors are capable of detecting even slight rotation of the primary pulley on the input shaft, and the secondary pulley on the output shaft. These sensors may be sensors which use, for example, magnetic resistance elements, which are generally referred to as semiconductor sensors.

The forward-reverse switching apparatus 290 includes a double pinion planetary gearset, a reverse brake (B1) 320, and an input clutch (C1) 310. In the planetary gearset, a sun gear S is connected to the input shat, a carrier CR which supports first and second pinions P1 and P2 is connected to the primary side fixed sheave, and a ring gear R is connected to the reverse brake (B1) 320 which serves as the reverse friction element. The input clutch (C1) 310 is disposed between the carrier CR and the sun gear S. The input clutch 310, which is also referred to as a forward clutch, is always applied whenever the vehicle is being driven forward, but is released when the vehicle is in park (P), reverse (R), or neutral (N).

Neutral control is control which puts the transmission in a state that resembles neutral, in which the input clutch 310 is released so as to be in a predetermined slip state (in this specification, the input clutch 310 in this state is also referred to as being “completely released”) when the vehicle is stopped in a case where the shift lever is in the drive (D) position and predetermined conditions with respect to the vehicle state are fulfilled.

As shown in FIG. 1, various signals are input to the ECU 1000 of an ECT (Electronic Controlled Automatic Transmission). These signals include a signal indicative of the turbine rotational speed NT from the turbine rotational speed sensor 400, a signal indicative of the primary pulley rotational speed NIN from the primary pulley rotational speed sensor 410, and a signal indicative of the secondary pulley rotational speed NOUT from the secondary pulley rotational speed sensor 420.

Referring to the drawing, the hydraulic pressure control portion 1100 includes a shift speed control portion 1110, a belt squeeze pressure control portion 1120, a lockup apply pressure control portion 1130, a clutch pressure control portion 1140, and a manual valve 1150. Control signals are output from the ECU 1000 to a shift control duty solenoid (1) 1200, a shift control duty solenoid (2) 1210, a linear solenoid 1220, a lockup solenoid 1230, and a lockup apply pressure control duty solenoid 1240, all of which are part of the hydraulic control portion 1100.

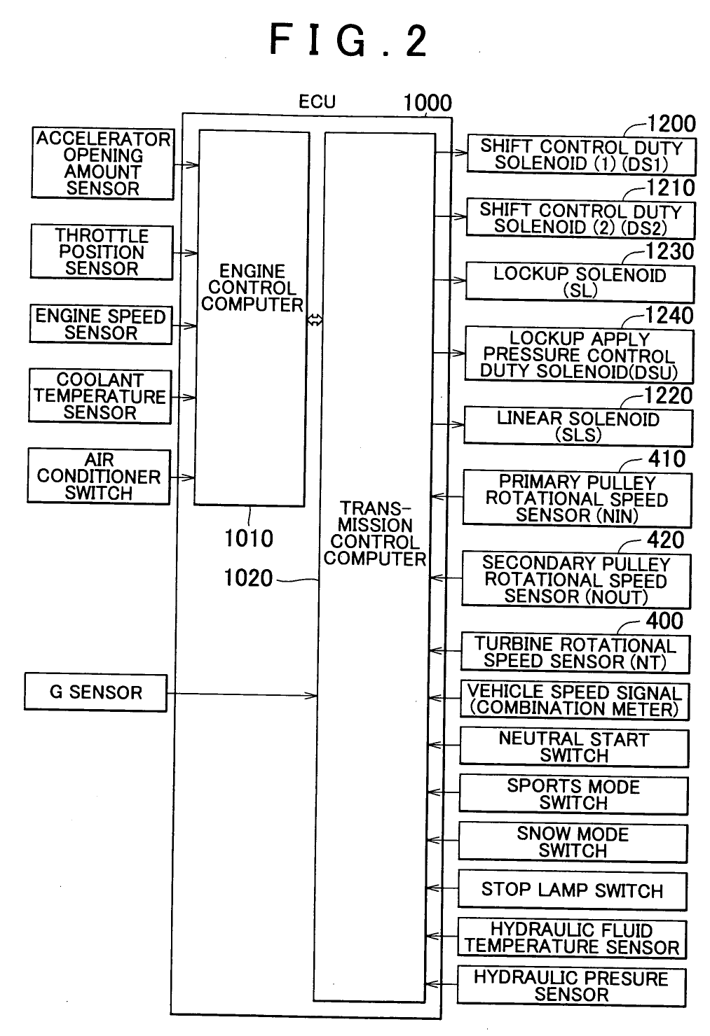

The construction of the ECU 1000 used to control the power train will now be described in further detail with reference to FIG. 2. As shown in the drawing, the ECU 1000 includes an engine control computer 1010 which controls the engine 100, and a transmission control computer 1020 which controls the torque converter 200, the forward-reverse switching apparatus 290, and the CVT 300.

In addition to the input signals shown in FIG. 1, various other signals are also input to the transmission control computer 1020. These signals include a signal from a stop lamp switch indicative of whether the brake pedal is being depressed by the driver, and a signal from the G sensor indicative of the angle of the incline when the vehicle is stopped on an incline or the like. Various signal are also input to the engine control computer 1010. These signals include a signal from an accelerator opening amount sensor indicative of an opening amount of an accelerator pedal depressed by the driver, a signal from a throttle position sensor indicative of an opening amount of an electromagnetic throttle, and a signal from an engine speed sensor indicative of the speed (NE) of the engine 100. The engine control computer 1010 and the transmission control computer 1020 are interconnected.

In the hydraulic pressure control portion 1100, the belt squeeze pressure control portion 1120 controls the squeeze pressure on the belt 700 of the CVT 300 and the clutch pressure control portion 1140 controls the apply pressure of the input clutch 310, based on the control signals output from the transmission control computer 1020 to the linear solenoid 1220.

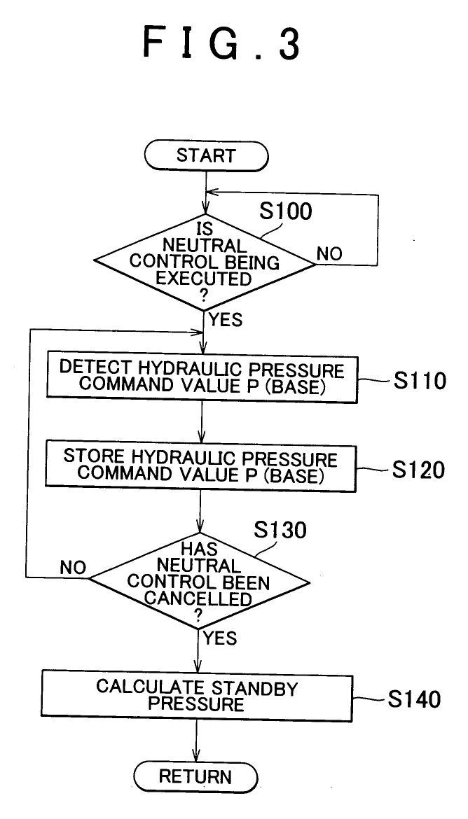

The control structure of a program for calculating a standby pressure when the neutral control is cancelled, the program being executed by the transmission control computer 1020 which serves as the control apparatus according to the exemplary embodiment of the invention will hereinafter be described with reference to FIG. 3.

In step S100, the transmission control computer 1020 determines whether the neutral control is being executed. This determination is made based on a flag or the like which is stored in a memory in the transmission control computer 1020 when the neutral control is started. If the neutral control is being executed (i.e., YES in step S100), the routine proceeds to step S510. If not (i.e., NO in step S100), step S100 is repeatedly performed until the neutral control is started.

In step S110, the transmission control computer 1020 detects a hydraulic pressure command value P (BASE) for the linear solenoid 1220. In step S120, the transmission control computer 1020 stores, in the memory thereof, the hydraulic pressure command value P (BASE) that has been detected in step S110.

In step S130, the transmission control computer 1020 determines whether the neutral control has been cancelled. If the neutral control has been cancelled (i.e., YES in step S130), the routine proceeds to step S140. If not (i.e., NO in step S130), step S110 is performed again. Then, the transmission control computer 1020 further detects the hydraulic pressure command value P (BASE) for the linear solenoid 1220, and stores the hydraulic pressure command value P (BASE) in the memory thereof.

In step S140, the transmission control computer 1020 calculates a standby pressure command value. For example, the standby pressure command value is obtained by adding a value ΔP (T) to the hydraulic pressure command value P (BASE) that has been stored in step S120.

Description will be made of the operation of a vehicle including a power train which is controlled by the transmission control computer which serves as the control apparatus according to the exemplary embodiment, based on the structure and flowchart described above.

If the neutral control is being executed (i.e., YES in step S100), the transmission control computer 1020 detects the hydraulic pressure command value P (BASE) for the linear solenoid 1220 (S110), and stores the detected hydraulic pressure command value P (BASE) in the memory thereof (S120). This routine is repeatedly executed until the neutral control is cancelled. Since the automatic transmission is in the neutral control mode at this time, the input clutch 310 is controlled such that the torque converter achieves a predetermined speed ratio or a predetermined slip rate, i.e., a predetermined slip state.

Thus, the transmission control computer 1020 controls the hydraulic pressure command value for the linear solenoid 1220 through feedback such that the torque converter 200 achieves a predetermined speed ratio. Therefore, the hydraulic pressure command value for the linear solenoid 1220 is calculated through feedback control, considering deviation due to individual difference of a hydraulic control device related to release and application of the input clutch 310 for achieving the neutral control, deviation of hydraulic characteristics of a solenoid valve and deviation of a load of a return spring of the input clutch 310, deviation of clutch clearance of the input clutch 310, and the like.

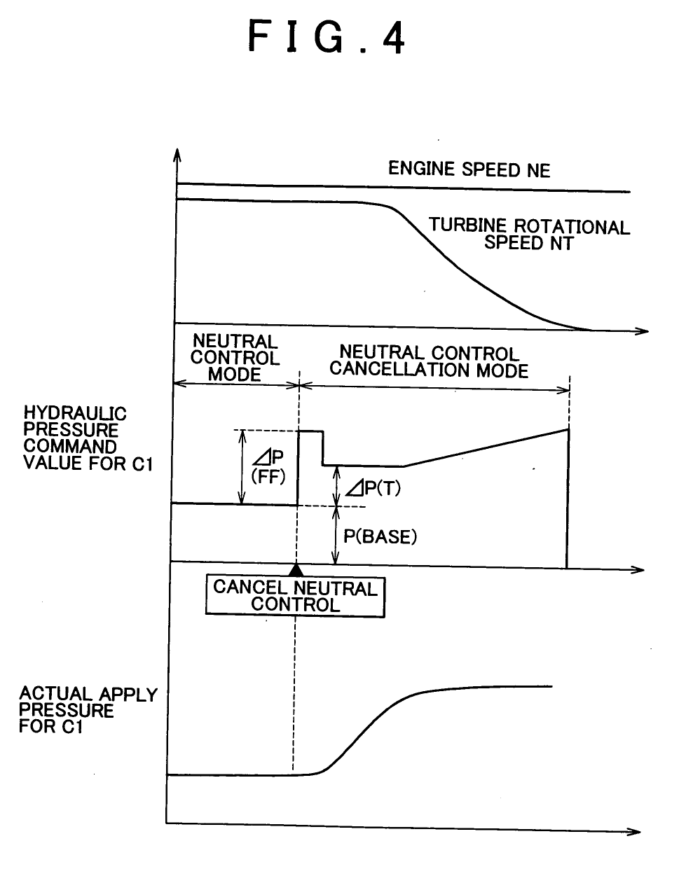

If the neutral control has been cancelled (i.e., YES in step S130), the transmission control computer 1020 calculates the standby pressure command value. As shown in FIG. 4, the standby pressure when the neutral control is cancelled is obtained by adding the value ΔP (T) to the hydraulic pressure value P (BASE) that is stored in the memory while the neutral control is being executed.

Also, in order to improve responsiveness, the transmission control computer 1220 outputs the hydraulic pressure command value obtained by adding the value ΔP (FF), which is larger than the value ΔP (T), to the hydraulic pressure value P (BASE) such that the hydraulic pressure command value becomes larger than the hydraulic pressure command value obtained by adding the value ΔP (T) to the hydraulic pressure value P (BASE), immediately after the neutral control is cancelled. By performing control in this manner, the apply pressure for the input clutch 310 is increased quickly when a neutral control cancellation mode starts. The increase in the actual apply pressure for the input clutch 310 decreases a turbine rotational speed NT.

Thus, the transmission control computer which serves as the control apparatus according to the exemplary embodiment calculates the standby pressure command value when the neutral control is cancelled by adding the predetermined value to the hydraulic pressure command value while the neutral control is being executed. Therefore, the transmission control computer can calculate the hydraulic pressure command value when the neutral control is cancelled without being influenced by individual difference of the hydraulic pressure control device. As a result, it is possible to provide the control apparatus for a power train which executes the neural control, and which can bring the automatic transmission out of the neutral state without causing a shock.

Further, in the exemplary embodiment, the automatic transmission is a belt type continuously variable transmission. However, the invention is not limited to the belt type continuously variable transmission, and can be applied to a toroidal type continuously variable transmission. Also, the invention can be applied to an automatic transmission including a fluid coupling or a torque converter and a planetary gear type speed reduction mechanism.

While the invention has been described with reference to exemplary embodiments thereof, is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A control apparatus for an automatic transmission which executes a neutral control by which an input clutch that transmits driving force from a driving source to the automatic transmission is released when conditions, being i) a shift lever is in a position corresponding to a forward speed range, ii) an accelerator operation is not being performed, iii) a brake operation is being performed, and iv) a vehicle speed is equal to, or less than, a predetermined vehicle speed, are fulfilled, comprising:
a controller which stores a hydraulic pressure command value for the input clutch while the neutral control is being executed, and which calculates, based on the stored hydraulic pressure command value, the hydraulic pressure command value for the input clutch when the neutral control is cancelled so that a normal control is restarted in a case where the conditions become unfulfilled.

2. The control apparatus for an automatic transmission according to claim 1, wherein a torque converter is provided in the automatic transmission; and the controller stores, as a hydraulic pressure base value, the hydraulic pressure command value for the input clutch for enabling the torque converter to achieve one of a predetermined speed ratio and a predetermined speed difference while the neutral control is being executed, and calculates the hydraulic pressure command value for the input clutch by adding a first predetermined value to the hydraulic pressure base value.

3. The control apparatus for an automatic transmission according to claim 2, wherein the controller calculates the hydraulic pressure command value for the input clutch by adding a second predetermined value, which is larger than the first predetermined value, to the hydraulic pressure base value before calculating the hydraulic pressure command value by adding the first predetermined value to the hydraulic pressure base value.

4. The control apparatus for an automatic transmission according to claim 2, wherein the controller stores, as the hydraulic pressure base value, the hydraulic pressure command value for the input clutch which is calculated through a feedback control such that the torque converter achieves one of a predetermined speed ratio and a predetermined speed difference while the neutral control is being executed.

5. A control apparatus for an automatic transmission which executes a neutral control by which an input clutch that transmits driving force from a driving source to the automatic transmission is released when conditions, being i) a shift lever is in a position corresponding to a forward speed range, ii) an accelerator operation is not being performed, iii) a brake operation is being performed, and iv) a vehicle speed is equal to, or less than, a predetermined vehicle speed, are fulfilled, comprising:
storing means for storing a hydraulic pressure command value for the input clutch while the neutral control is being executed; and
calculating means for calculating, based on the stored hydraulic pressure command value, the hydraulic pressure command value for the input clutch when the neutral control is cancelled so that a normal control is restarted in a case where the conditions become unfulfilled.

6. The control apparatus for an automatic transmission according to claim 5, wherein a torque converter is provided in the automatic transmission; the storing means stores, as a hydraulic pressure base value, the hydraulic pressure command value for the input clutch for enabling the torque converter to achieve one of a predetermined speed ratio and a predetermined speed difference while the neutral control is being execute; and the calculating means calculates the hydraulic pressure command value for the input clutch by adding a first predetermined value to the hydraulic pressure base value.

7. The control apparatus for an automatic transmission according to claim 6, wherein the calculating means calculates the hydraulic pressure command value for the input clutch by adding a second predetermined value, which is larger than the first predetermined value, to the hydraulic pressure base value before calculating the hydraulic pressure command value by adding the first predetermined value to the hydraulic pressure base value.

8. The control apparatus for an automatic transmission according to claim 6, wherein the storing means stores, as the hydraulic pressure base value, the hydraulic pressure command value for the input clutch which is calculated through a feedback control such that the torque converter achieves one of a predetermined speed ratio and a predetermined speed difference while the neutral control is being executed.

9. A control method for an automatic transmission which executes a neutral control by which an input clutch that transmits driving force from a driving source to the automatic transmission is released when conditions, being i) a shift lever is in a position corresponding to a forward speed range, ii) an accelerator operation is not being performed, iii) a brake operation is being performed, and iv) a vehicle speed is equal to, or less than, a predetermined vehicle speed, are fulfilled, comprising the steps of:
storing a hydraulic pressure command value for the input clutch while the neutral control is being executed; and
calculating, based on the stored hydraulic pressure command value for the input clutch, the hydraulic pressure command value for the input clutch when the neutral control is cancelled so that a normal control is restarted in a case where the conditions become unfulfilled.

10. The control method for an automatic transmission according to claim 9, further comprising the steps of:
storing, as a hydraulic pressure base value, the hydraulic pressure command value for the input clutch for enabling the torque converter to achieve one of a predetermined speed ratio and a predetermined speed difference while the neutral control is being executed; and
calculating the hydraulic pressure command value for the input clutch by adding a first predetermined value to the hydraulic pressure base value.

11. The control method for an automatic transmission according to claim 10, further comprising the step of:
calculating the hydraulic pressure command value for the input clutch by adding a second predetermined value, which is larger than the first predetermined value, to the hydraulic pressure base value before calculating the hydraulic pressure command value for the input clutch by adding the first predetermined value to the hydraulic pressure base value.

12. The control method for an automatic transmission according to claim 10, wherein the hydraulic pressure command value for the input clutch which is calculated such that the torque converter achieves one of a predetermined speed ratio and a predetermined speed difference is stored as the hydraulic pressure base value while the neutral control is being executed.
